(19) United States
(12) Patent Application Publication
(10) Pub. No.: US 2023/0400143 A1
(43) Pub. Date: Dec. 14, 2023

(54) MULTIPLE-ANGLE DISPLAY ADJUSTING DEVICE

(71) Applicant: OXTI Pte Ltd, Singapore (SG)

(72) Inventor: Chih-Feng Ho, Singapore (SG)

(21) Appl. No.: 17/838,276

(22) Filed: Jun. 13, 2022

(51) Int. Cl. F16M 11/18; F16M 11/20; F16M 11/12

(52) U.S. Cl. CPC F16M 11/18; F16M 11/2092; F16M 11/126; F16M 11/2014

(57) ABSTRACT

A multiple-angle display adjusting device includes a display, which is drivable by a driving mechanism to rotate; a support frame, which is connected to the display; and a track, which is arranged at one side of the support frame to allow the support frame to slide on and along the track. A base is arranged at one side of the track, and the track is rotatable relative to the base. As such, according to differences in respect of height/body size or operation preference between different users, proper adjustments in respect of distance and orientation can be made through having the support frame slide along the track to achieve adjustment of a distance between the display and the user and also through having the track rotate relative to the base to achieve adjustment of an orientation between the display and the user.

### TECHNICAL FIELD OF THE INVENTION

The present invention relates generally to a display, and more particularly to a multiple-angle display adjusting device.

### DESCRIPTION OF THE PRIOR ART

Taiwan Utility Model M326655 discloses a display retaining stand base, which includes a main body having a body part, a base part, a pivoting part, and a retaining part. The document shows, in FIG. 6 thereof, the retaining part is penetrated with two threaded fasteners, and the two threaded fasteners are mounted to two pivoting troughs by means of two nuts. Further, the retaining part is provided with a tightening piece, and the tightening piece tightens the retaining part. The tightening piece is driven by a tightening rod. As such, advantages of adjusting a frontward-rearward elevation angle and a horizontal rotation angle can be realized.

However, such a known technology is only applicable to adjustment of the leftward-rightward rotation angle and the inclination elevation angle of a display according to a single user's preference of use. In other words, the display can only be allowed to rotate, but it is not possible to do adjustment in respect of a proper distance and direction in response to the body heights or differences of operation preference for different users. Thus, there is still room for improvements.

### SUMMARY OF THE INVENTION

To achieve the above purpose, the present invention provides a multiple-angle display adjusting device, which comprises: a display, which is drivable by a driving mechanism to rotate; a support frame, which is connected to the display; and a track, which is arranged at one side of the support frame to allow the support frame to slide on and along the track.

In the multiple-angle display adjusting device, a base is arranged at one side of the track, and the track is rotatable relative to the base.

In the multiple-angle display adjusting device, the driving mechanism comprises a motor controller, at least one motor, and at least one axle. The at least one axle is connected to the display, and the motor controller is operable to control the at least one motor to drive the at least one axle to drive the display to rotate.

In the multiple-angle display adjusting device, the driving mechanism is electrically connected with a sensor.

In the multiple-angle display adjusting device, the track is in a linear form.

As such, according to differences in respect of height/body size or operation preference between different users, proper adjustments in respect of distance and orientation can be made through having the support frame slide along the track to achieve adjustment of a distance between the display and the user and also through having the track rotate relative to the base to achieve adjustment of an orientation between the display and the user. Further, the display is rotatable in an automatic manner as being drivable by the driving mechanism, so that the user is allowed to watch the display at a multiplicity of angles, making it particularly applicable to a narrow space, such as an office, in which moving the display may be difficult.

### BRIEF DESCRIPTION OF THE DRAWINGS

FIG. 1 is a perspective view showing a multiple-angle display adjusting device according to the present invention.

FIG. 2 is a side elevational view showing the multiple-angle display adjusting device according to the present invention.

FIG. 3 is a top plan view showing the multiple-angle display adjusting device according to the present invention.

FIG. 4 is a schematic view demonstrating a display of the present invention approaching a user.

FIG. 5 is a schematic view demonstrating a driving mechanism driving the display to rotate for a minute extent.

FIG. 6 is a schematic view demonstrating a track of the present invention rotating relative to a base.

### DETAILED DESCRIPTION OF THE PREFERRED EMBODIMENT

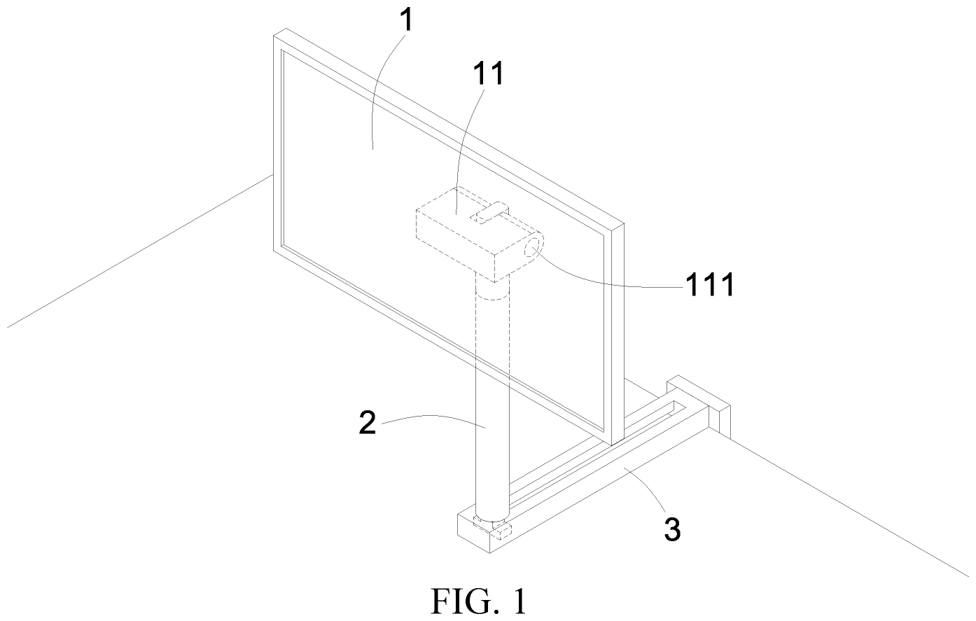

Referring to FIG. 1, the present invention provides a multiple-angle display adjusting device, which comprises: a display 1, a support frame 2, and a track 3.

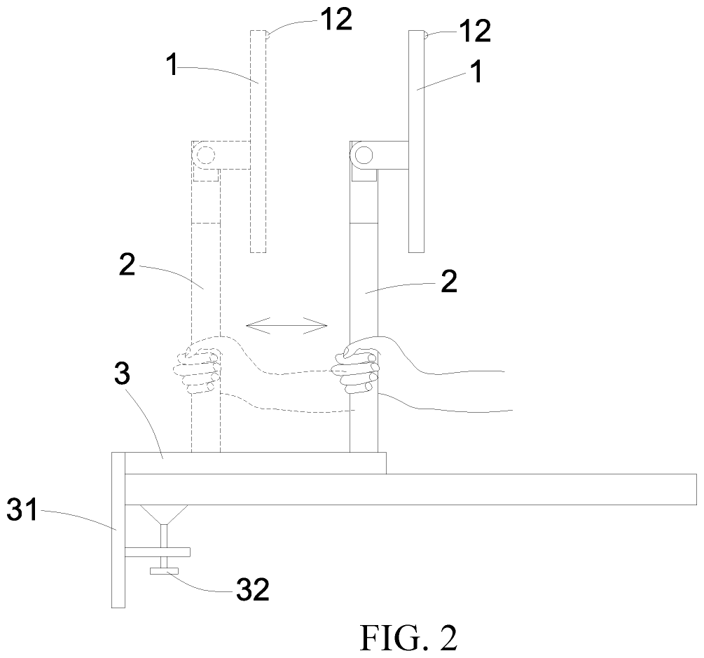

The display 1 is drivable by a driving mechanism 11 to rotate. Specifically, the driving mechanism 11 may comprise a motor controller, at least one motor, and at least one axle 111. The at least one axle 111 and the display 1 are interconnected. The motor controller is operable to control the at least one motor to drive the at least one axle 111 to drive the display 1 to rotate. For example, a first motor and a first axle (which serves as a horizontal rotating axle of the display 1 to allow the display 1 to rotate upwards/downwards about a center defined by the first axle) may be provided to enable the display 1 to rotate upwards/downwards, and additionally or alternatively, a second motor and a second axle (which serves as a vertical rotating axle of the display 1 to allow the display 1 to rotate leftwards/rightwards about a center defined by the second axle) may be provided to enable the display 1 to rotate leftwards/rightwards, so that the display may possess both functions of rotating upwards/downwards and rotating leftwards/rightwards. Referring to FIG. 2, further, the driving mechanism 11 is electrically connected with a sensor 12. The sensor 12 functions to detect a user. The sensor 12 may be an image sensor, which captures an image of a face and is operable to apply facial recognition technology to identify a position of a face according to distances among the eyebrows, the eyes, the nose, the teeth, and the mouth so as to identify an orientation of the head. The orientation of the head can be for example head upwards, head downwards, head leftwards, or head rightwards. The sensor 12 may then transmit information of the position of the face and the orientation of the head toward the driving mechanism 11. The sensor 12 is arrangeable on the display 1 or the support frame 2.

Referring to FIG. 1, the support frame 2 and the display 1 are connected to each other. Specifically, the support frame 2 is arranged at one end of the display 1. The support frame 2 is generally in the form of a pillar.

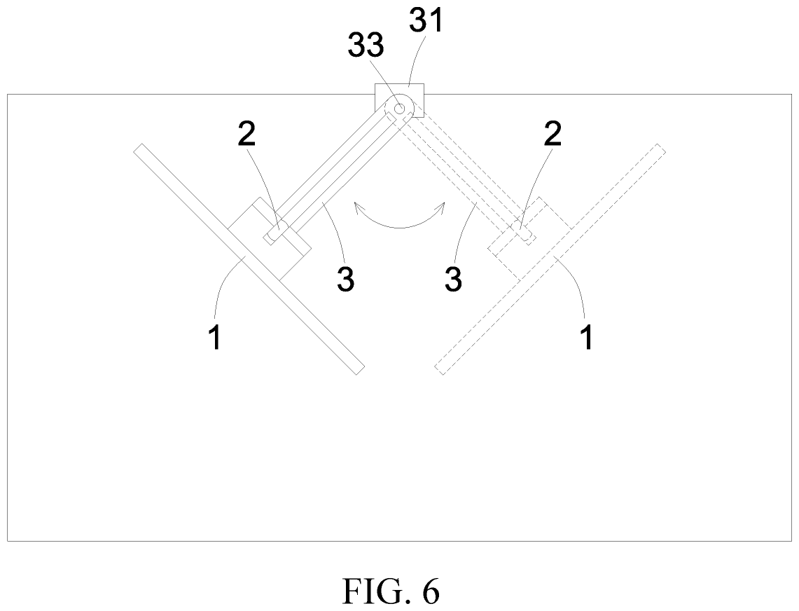

Referring to FIGS. 2 and 6, the track 3 is arranged at one side of the support frame 2 to allow the support frame 2 to slide on and along the track 3. Specifically, the track 3 is in a linear form. Further, the track 3 is provided, at one side thereof, with a base 31, and the track 3 is rotatable relative to the base 31. The base 31 is provided with a fastening member 32 and a rotary shaft 33 (shown in FIG. 6). The fastening member 32 functions to fix the base 31 to a desktop, and the rotary shaft 33 functions to enable relative rotation of the track 3 with respect to the base 31.

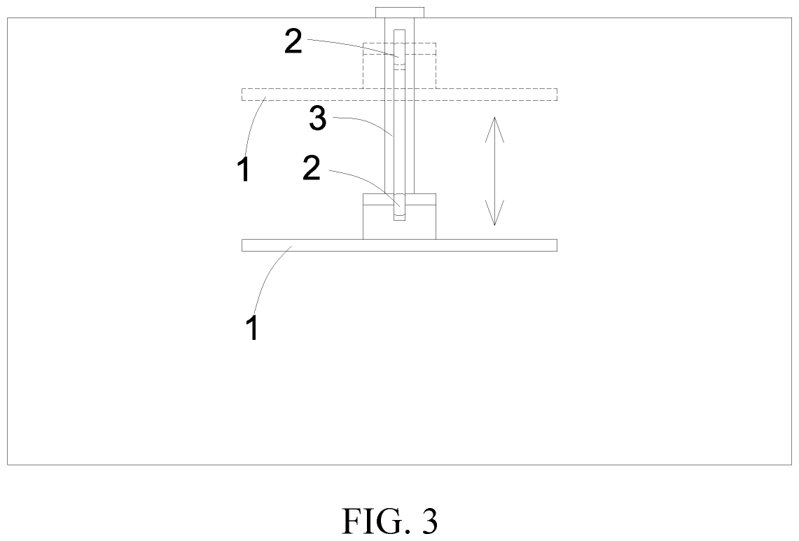

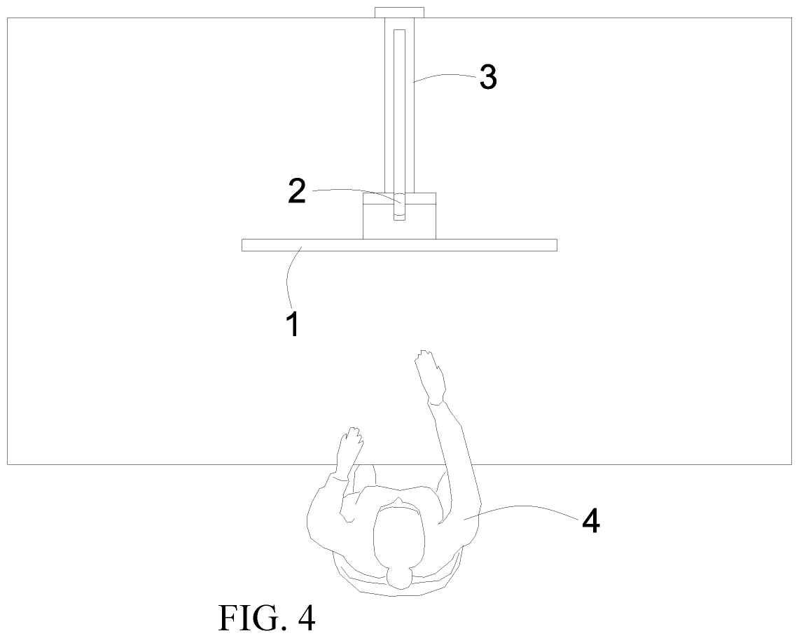

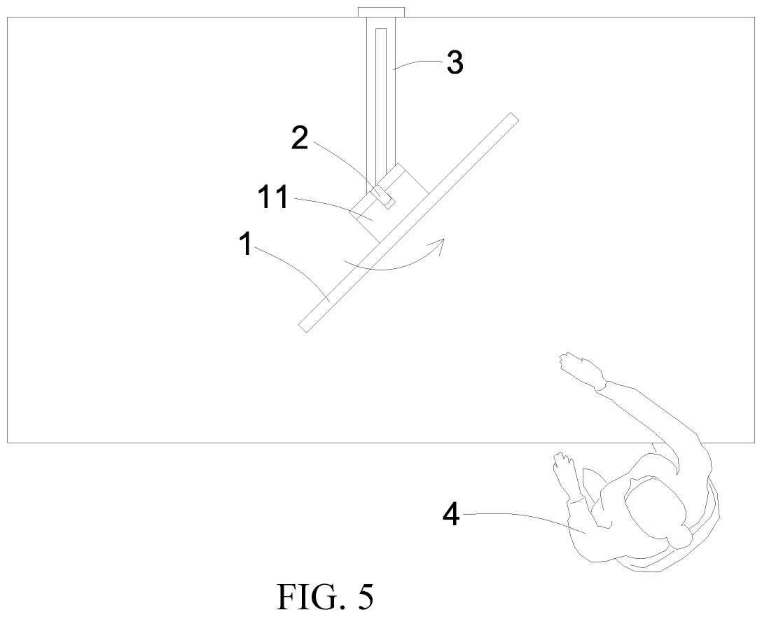

Referring to FIGS. 2, 3, and 4, in use of the present invention, firstly, a user 4 manually moves the support frame 2 from one end of the track 3 toward an opposite end of the track 3 to make the display 1 approaching or away from the user 4, so as to adjust a distance between the display 1 and the user 4. Referring to FIGS. 2 and 5, the sensor 12 is put in operation to detect the user 4, and the driving mechanism 11 is put into operation to drive the display 1 to do rotation for a minute extent, so as to have the display 1 facing the user 4. Referring to FIG. 6, further, the base 31 is provided with the rotary shaft 33, and the user 4 may do a manual operation to have the track 3 rotated relative to the base 31, so as to adjust an orientation between the display 1 and the user 4.

As such, according to differences in respect of height/body size or operation preference between different users 4, proper adjustments in respect of distance and orientation can be made through having the support frame 2 slide along the track 3 to achieve adjustment of a distance between the display 1 and the user 4 and also through having the track 3 rotate relative to the base 31 to achieve adjustment of an orientation between the display 1 and the user 4. Further, the display 1 is rotatable in an automatic manner as being drivable by the driving mechanism 11, so that the user 4 is allowed to watch the display 1 at a multiplicity of angles, making it particularly applicable to a narrow space, such as an office, in which moving the display 1 may be difficult.

I claim:

1. A multiple-angle display adjusting device, comprising:
a display, which is drivable by a driving mechanism to rotate;
a support frame, which is connected to the display; and
a track, which is arranged at one side of the support frame to allow the support frame to slide on and along the track.

2. The multiple-angle display adjusting device according to claim 1, wherein a base is arranged at one side of the track, and the track is rotatable relative to the base.

3. The multiple-angle display adjusting device according to claim 1, wherein the driving mechanism comprises a motor controller, at least one motor, and at least one axle, the at least one axle being connected to the display, the motor controller being operable to control the at least one motor to drive the at least one axle to drive the display to rotate.

4. The multiple-angle display adjusting device according to claim 1, wherein the driving mechanism is electrically connected with a sensor.

5. The multiple-angle display adjusting device according to claim 1, wherein the track is in a linear form.
